(19) United States
(12) Patent Application Publication
(10) Pub. No.: US 2024/0334922 A1
(43) Pub. Date: Oct. 10, 2024

(54) SYSTEM AND METHOD FOR AN AGRICULTURAL APPLICATOR

(71) Applicants: CNH Industrial America LLC, New Holland, PA (US); Kansas State University Research Foundation, Manhattan, KS (US)

(72) Inventors: Rex Leroy Ruppert, Benson, MN (US); Brent David Bast, Sioux Falls, SD (US); Ajay Sharda, Manhattan, KS (US)

(21) Appl. No.: 18/131,739

(22) Filed: Apr. 6, 2023

(51) Int. Cl. A01M 7/00

(52) U.S. Cl. CPC A01M 7/0089; A01M 7/0057

(57) ABSTRACT

An agricultural system can include a product application system including one or more nozzle assemblies. A sensing system can be configured to capture data indicative of a condition of a spray operation. An input device can be configured to receive a first command to alter an application parameter for an agricultural product to be exhausted from a nozzle assembly. A computing system can be communicatively coupled to the product application system, the sensing system, and the input device. The computing system can be configured to receive the first command to alter the parameter, alter a first component based on the first command, determine whether the condition of the spray operation deviates from a defined condition range in response to altering the first component, and generate a second command to alter a second component based on the first command.

### FIELD

The present disclosure generally relates to agricultural implements and, more particularly, to systems and methods for a spray operation.

### BACKGROUND

Various types of work vehicles utilize applicators (e.g., sprayers, floaters, etc.) to deliver an agricultural product to a field of a field. The agricultural product may be in the form of a solution or mixture, with a carrier (such as water) being mixed with one or more active ingredients (such as an herbicide, agricultural product, fungicide, a pesticide, or another product).

The applicators may be pulled as an implement or self-propelled and can include a tank, a pump, a boom assembly, and a plurality of nozzles carried by the boom assembly at spaced locations. The boom assembly can include a pair of boom arms, with each boom arm extending to either side of the applicator when in an unfolded state. Each boom arm may include multiple boom sections, each with a number of spray nozzles (also sometimes referred to as spray tips).

The spray nozzles on the boom assembly disperse the agricultural product carried by the applicator onto a field. During a spray operation, however, various factors may affect a quality of the application of the agricultural product to the field. Accordingly, an improved system and method for the application of the agricultural product to the field would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a method for an agricultural application operation. The method includes receiving, through an input device, a first command to alter a parameter of an agricultural vehicle. The method also includes altering, with a computing system, a first component of the vehicle based on the first command. The method further includes determining, with the computing system, if any of one or more conditions respectively deviate from a defined condition range in response to altering the first component. Lastly, the method includes generating, with the computing system, a second command to alter a second component of the vehicle based in part on the one or more conditions respectively deviating from the defined condition range.

In some aspects, the present subject matter is directed to an agricultural system that includes a product application system including one or more nozzle assemblies. A sensing system is configured to capture data indicative of a condition of a spray operation. An input device is configured to receive a first command to alter an application parameter for an agricultural product to be exhausted from a nozzle assembly. A computing system communicatively coupled to the product application system, the sensing system, and the input device. The computing system is configured to receive the first command to alter the parameter, alter a first component based on the first command, determine whether the condition of the spray operation deviates from a defined condition range in response to altering the first component, and generate a second command to alter a second component based on a prediction that the alteration of the first component will cause the condition of the spray operation to deviate from the defined condition range.

In some aspects, the present subject matter is directed to a method for an agricultural application operation. The method includes receiving, through an input device, a first command to alter a boom from a first height to a second height relative to a field. The method also includes moving, with a suspension system, the boom to the second height. The method further includes determining, with a computing system, if a condition of a spray operation deviates from a defined condition range in response to moving the boom to the second height. Lastly, the method includes generating, with the computing system, a second command to alter a component based in part on the condition of the spray operation deviating from the defined condition range prior to the boom being placed at the second height.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural work vehicle in accordance with aspects of the present subject matter;

FIG. 2 illustrates a side view of the work vehicle in accordance with aspects of the present subject matter:

FIG. 3 is an enhanced view of section III of FIG. 1 illustrating a rear view of a portion of a boom assembly in accordance with aspects of the present subject matter:

FIG. 4 illustrates a block diagram of components of the agricultural applicator system in accordance with aspects of the present subject matter:

FIG. 5 is a schematic block diagram illustrating portions of the computing system within the agricultural applicator system in accordance with aspects of the present subject matter; and

FIG. 6 illustrates a flow diagram of a method for an agricultural application operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone: B alone: C alone: A and B in combination: A and C in combination: B and C in combination: or A, B, and C in combination.

In general, the present subject matter is directed to agricultural system that includes a product application system including one or more nozzle assemblies. A sensing system can be configured to capture data indicative of a condition of a spray operation. In various examples, an input device can be configured to receive a first command to alter an application parameter for an agricultural product to be exhausted from a nozzle assembly.

In some examples, a computing system can be communicatively coupled to the product application system, the sensing system, and the input device. The computing system can be configured to receive a first command to alter a parameter of an agricultural vehicle, alter a first component of the vehicle based on the first command, determine if any of one or more conditions respectively deviate from a defined condition range in response to altering the first component, and generate a second command to alter a second component of the vehicle based in part on the one or more conditions respectively deviating from the defined condition range. The system provided herein may provide closed-loop control for monitoring and/or generating one or more commands to alter one or more components of the vehicle based on the received commands and/or the received data, which may allow for corrective actions to accommodate various operator commands. With the corrective actions, one or more conditions of the spray operation may return to a defined condition range and/or preemptively be maintained within the defined condition range in instances in which the corrective action is performed contemporaneously with the commanded action.

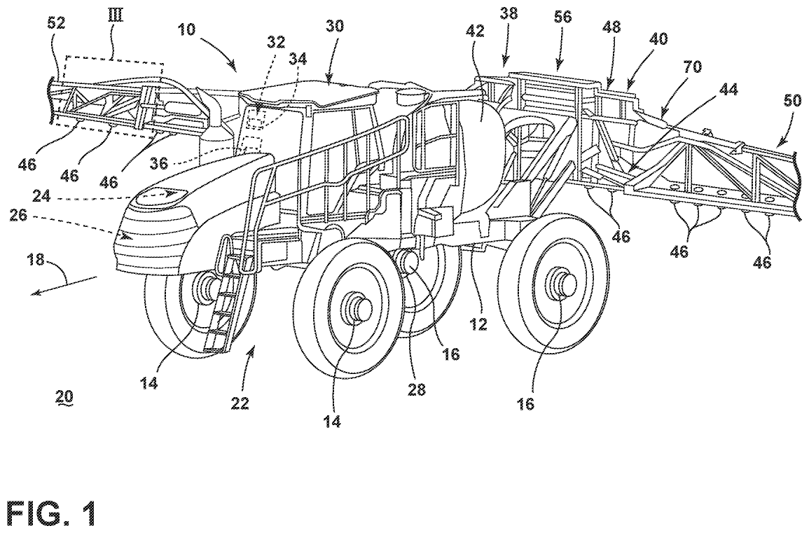

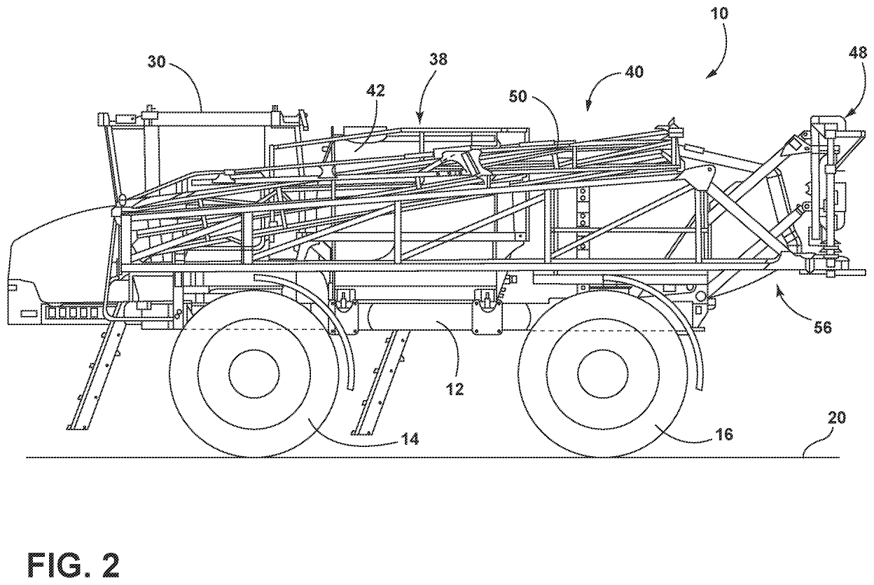

Referring now to FIGS. 1 and 2, a work vehicle 10 is generally illustrated as a self-propelled agricultural applicator. However, in alternate embodiments, the work vehicle 10 may be configured as any other suitable type of work vehicle 10 configured to perform agricultural application operations, such as a tractor or other vehicle configured to haul or tow an application implement.

In various embodiments, the work vehicle 10 may include a chassis 12 configured to support or couple to a plurality of components. For example, front and rear wheels 14, 16 may be coupled to the chassis 12. The wheels 14, 16 may be configured to support the work vehicle 10 relative to a field 20 and move the work vehicle 10 in a direction of travel (e.g., as indicated by arrow 18 in FIG. 1) across the field 20. In this regard, the work vehicle 10 may include a powertrain control system 22 that includes a power plant 24, such as an engine, a motor, or a hybrid engine-motor combination, a hydraulic propel or transmission system 26 configured to transmit power from the engine to the wheels 14, 16, and/or a brake system 28.

The chassis 12 may also support a cab 30, or any other form of user's station, for permitting the user to control the operation of the work vehicle 10. For instance, as shown in FIG. 1, the work vehicle 10 may include a user interface 32 having a display 34 for providing messages and/or alerts to the user and/or for allowing the user to interface with the vehicle's controller through one or more user input devices 36 (e.g., levers, pedals, control panels, buttons, and/or the like).

The chassis 12 may also support a boom assembly 38 mounted to the chassis 12. In addition, the chassis 12 may support a product application system 40 that includes one or more tanks 42, such as a rinse tank and/or a product tank. The product tank is generally configured to store or hold an agricultural product, such as a pesticide, a fungicide, a rodenticide, a nutrient, and/or the like. The agricultural product is conveyed from the product tank through plumbing components, such as interconnected conduits 44, for release onto the underlying field 20 (e.g., plants and/or soil) through one or more nozzle assemblies 46 mounted on the boom assembly 38.

As shown in FIGS. 1 and 2, the boom assembly 38 can include a frame 48 that supports first and second boom arms 50, 52, which may be orientated in a cantilevered nature. The first and second boom arms 50, 52 are generally movable between an operative or unfolded position (FIG. 1) and an inoperative or folded position (FIG. 2) through one or more actuators 62. When distributing the product, the first and/or second boom arm 50, 52 extends laterally outward from the work vehicle 10 to cover swaths of the underlying field 20, as illustrated in FIG. 1. However, to facilitate transport, each boom arm 50, 52 of the boom assembly 38 may be independently folded forwardly or rearwardly into the inoperative position, thereby reducing the overall width of the vehicle 10, or in some examples, the overall width of a towable implement when the applicator is configured to be towed behind the work vehicle 10.

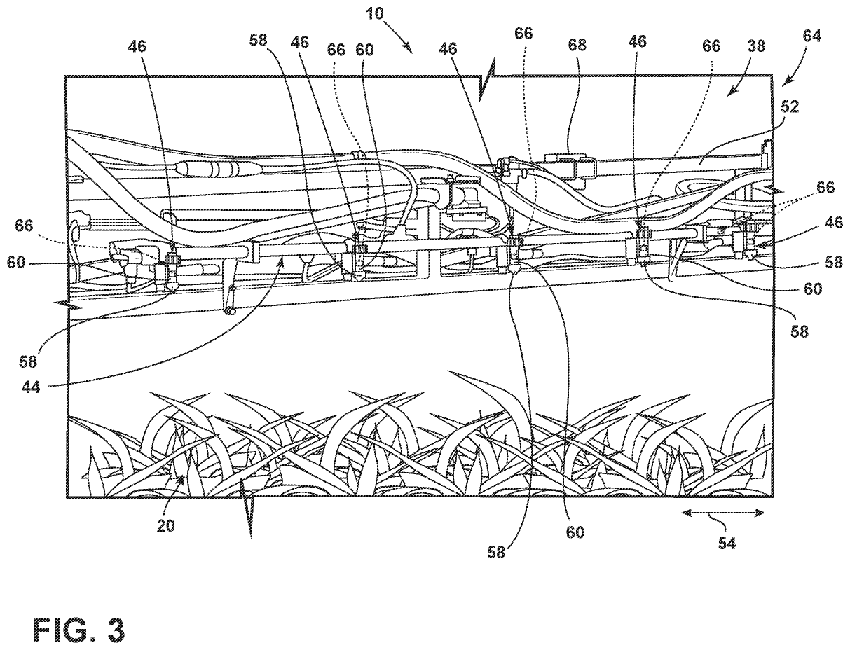

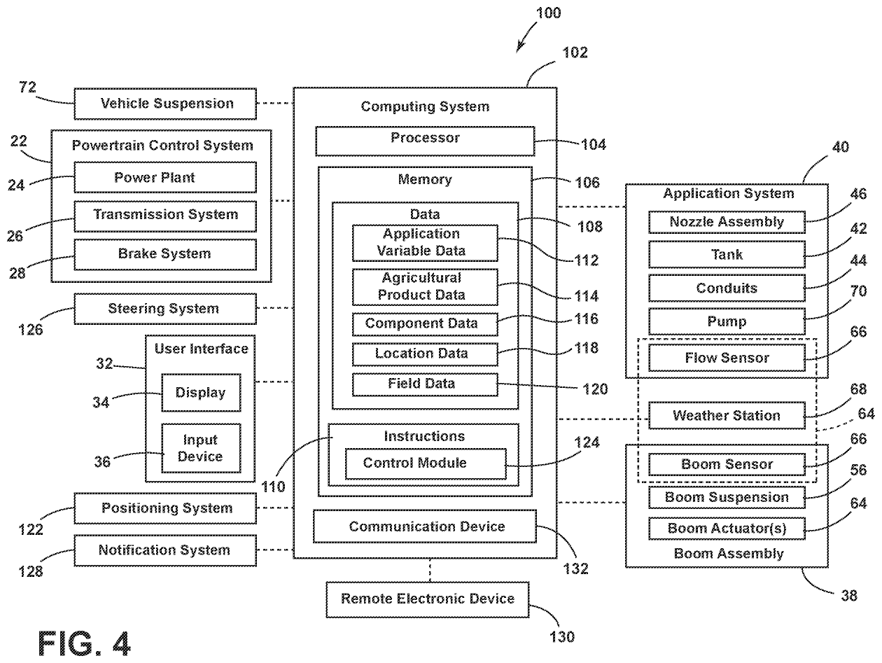

In some examples, a boom suspension 56 may be configured to dampen the movement of the boom frame 48 relative to a mast, thereby providing a more stable platform for the boom assembly 38. The boom suspension 56 may allow for various damping levels based on an operator input and/or such damping levels may be automatically altered or selected by a computing system 102 (FIG. 4) (e.g., based on data received from one or more sensors 66 (FIG. 3). In various examples, the boom suspension 56 may be automatically adjusted based on data received from another system or sub-systems of the vehicle 10 as well. For instance, the boom suspension 56 may alter the position of the frame 48 of the boom assembly 38 relative to the field 20 and/or the chassis 12.

Referring to FIG. 3, the boom assembly 38 may be configured to support a plurality of nozzle assemblies 46. Each nozzle assembly 46 may be configured to dispense an agricultural product stored within the tank 42 (FIG. 1) onto the underlying field 20. In several embodiments, the nozzle assemblies 46 may be mounted on and/or operably coupled to the first boom arm 50, the second boom arm 52, and/or the frame 48 of the boom assembly 38, with the nozzle assemblies 46 being spaced apart from each other along a lateral direction 54. Furthermore, fluid conduits 44 may fluidly couple the nozzle assemblies 46 to the tank 42. In this respect, as the work vehicle 10 travels across the field 20 in the direction of travel 18 to perform a spray operation thereon, the agricultural product moves from the tank 42 through the fluid conduit 44 to each of the nozzle assemblies 46. The nozzle assemblies 46 may, in turn, dispense or otherwise spray a fan of the agricultural product onto the underlying field 20.

Referring still to FIG. 3, the nozzle assembly 46 may generally include a nozzle 58 and a valve 60. The valve 60 may be configured to regulate an amount of agricultural product that flows therethrough through any manner, such as through pulse width modulation (PWM). The nozzle 58 includes a nozzle body configured to receive the agricultural product flowing through the fluid conduits 44 and a nozzle head mounted to and/or formed integrally with the nozzle body. For example, the nozzle 58 may be configured as a flat fan nozzle configured to dispense a flat fan of the agricultural product. However, in alternative embodiments, the nozzle 58 may be configured as any other suitable type of nozzle, such as dual pattern nozzles and/or hollow cone nozzles.

With further reference to FIG. 3, during a spray operation, various spray quality parameters may affect a spray quality of the application of the agricultural product, which can be computed into a spray quality index in which the spray quality index represents a metric indicative of a spray operation coverage of a portion of a field 20. In some instances, the spray quality index may be used to determine whether the agricultural product was applied to various portions of the field 20 within a defined range and/or misapplied to various portions of the field 20 by deviating from the defined range. In several embodiments, the one or more spray quality parameters that may affect the spray quality can include at least one of an airflow at each nozzle assembly 46, a nozzle tip size and style, which agricultural product is being applied, an incorrect agricultural product application rate, inclement weather as determined by meeting one or more criteria, an agricultural product application rate or pressure deviating from a predefined range, boom assembly movement (e.g., jounce) deviating from a movement range, a vehicle speed deviating from a predefined speed, a vehicle acceleration/deceleration deviating from a predefined range, a turning radius deviating from predefined criteria, and/or any other variable.

In accordance with aspects of the present subject matter, a sensing system 64 may include one or more sensors 66, a weather station 68, and/or any other assembly, which may be installed on the vehicle 10 and/or the boom assembly 38. In general, the sensing system 64 may be configured to capture data indicative of one or more spray quality parameters associated with the fans of the agricultural product being dispensed by the nozzle assemblies 46. The spray quality parameter(s) may, in turn, be indicative of the quality of the spray operation, such as whether a target application rate of the agricultural product is within a defined range. The sensors 66 may include position sensors, flow sensors, motion sensors (e.g., accelerometers, gyroscopes, etc.), image sensors (e.g., cameras, LIDAR devices, etc.), radar sensors, ultrasonic sensors, and/or the like, depending on the operating conditions being monitored. In addition, the weather station 68 may be configured to capture data indicative of a wind speed and direction at a defined position on the work vehicle 10. The mobile weather station 68 can contain any sensor that may be found on a stationary weather station that monitors one or more weather criteria, such as temperature, wind speed, wind direction, relative humidity, barometric pressure, cloud cover, and trends thereof.

During the operation of the vehicle 10, an operator may provide a first command to alter one or more parameters related to one or more components of the vehicle 10. Based on the first command, a first component of the vehicle 10 may be altered. In addition, a computing system 102 (FIG. 4) may determine whether a condition of a spray operation deviates from a defined condition range in response to altering the first component and generate a second command to alter a second component of the vehicle 10 based on a prediction that the alteration of the first component will cause the condition of a spray operation to deviate from the defined condition range. In various embodiments, the second commands may be determined through various geometric equations, lookup tables (LUTs), and/or any other method to determine an alteration to any component of the vehicle 10.

Referring now to FIG. 4, a schematic view of the system 100 for operating the work vehicle 10 is illustrated in accordance with aspects of the present subject matter. In general, the system 100 will be described with reference to the work vehicle 10 described above with reference to FIGS. 1-3. However, it should be appreciated by those of ordinary skill in the art that the disclosed system 100 may generally be utilized with agricultural machines having any other suitable machine configuration. Additionally, it should be appreciated that, for purposes of illustration, communicative links, or electrical couplings of the system 100 shown in FIG. 4 are indicated by dashed lines.

As shown in FIG. 4, the system 100 may include a computing system 102 operably coupled with the product application system 40 and/or the boom assembly 38 to dispense an agricultural product from the product application system 40 to the field 20 (FIG. 1) through one or more nozzle assemblies 46 that may be positioned at least partially along the boom assembly 38. The product application system 40 may include the one or more tanks 42 that are configured to retain an agricultural product. A fluid conduit 44 is fluidly coupled with the tank 42 and a pump 70. In several embodiments, the pump 70 may be a diaphragm, a piston, a scroll, or another pumping assembly.

In general, the computing system 102 may be configured as any suitable processor-based device, such as a computing device or any suitable combination of computing devices. Thus, in several embodiments, the computing system 102 may include one or more processors 104 and associated memory 106 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 106 of the computing system 102 may generally comprise memory elements including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 106 may generally be configured to store information accessible to the processor 104, including data 108 that can be retrieved, manipulated, created, and/or stored by the processor 104 and instructions 110 that can be executed by the processor 104, when implemented by the processor 104, configure the computing system 102 to perform various computer-implemented functions, such as one or more aspects of the image processing algorithms and/or related methods described herein. In addition, the computing system 102 may also include various other suitable components, such as a communications circuit or module, one or more input/output channels, a data/control bus, and/or the like.

In various embodiments, the computing system 102 may correspond to an existing controller of the agricultural work vehicle 10, or the computing system 102 may correspond to a separate processing device. For instance, in some embodiments, the computing system 102 may form all or part of a separate plug-in module or computing device that is installed relative to the work vehicle 10 or the boom assembly 38 to allow for the disclosed system 100 and method to be implemented without requiring additional software to be uploaded onto existing control devices of the work vehicle 10 or the boom assembly 38. Further, the various functions of the computing system 102 may be performed by a single processor-based device or may be distributed across any number of processor-based devices, in which instance such devices may be considered to form part of the computing system 102. For instance, the functions of the computing system 102 may be distributed across multiple application-specific controllers, such as a pump controller, individual nozzle controllers, and/or the like.

In several embodiments, the data 108 may be information received and/or generated by the computing system 102 that is stored in one or more databases. As provided herein, a sensing system 64 may include one or more sensors 66, a weather station 68, and/or any other assembly, which may be installed on the vehicle 10 and/or the boom assembly 38 for collecting the data 108. For instance, as shown in FIG. 4, the memory 106 may include an application variable database 112 for storing application variable data that is received from the various components of the system 100, such as the sensing system 64. Moreover, in addition to initial or raw sensor data received from the various components, final or post-processing application variable data (as well as any intermediate application variable data created during data processing) may also be stored within the application variable database 112. In the example illustrated in FIG. 4, at least a portion of the application variable data provided to the memory 106 may be received from the product application system 40. For example, a flow condition within the product application system 40 and/or within one or more nozzle assemblies 46 of the product application system 40 may be stored within the application variable database 112.

In various embodiments, the memory 106 may also include an agricultural product database 114 that stores product information. The product information may include various information regarding the conditions and rates of application for an individual product that is to be applied to the field 20. In some instances, the product information may be preloaded or sent to the vehicle 10 via wired or wireless communication therewith. Additionally or alternatively, the product information may be manually inputted into the database. In some embodiments, based on the selected product information, a different spray quality index, acceptable application rate range, acceptable application droplet size range, acceptable application pressure range, and/or any other characteristic may be selected.

In several embodiments, the memory 106 may also include a vehicle component database 116 that stores component information. For example, the vehicle component database 116 may store information regarding the position of various components of the vehicle 10 relative to one another and/or the field 20. For instance, a position of the boom assembly 38 relative to the field 20, crops within the field 20, and/or the chassis 12 (FIG. 1) of the vehicle 10 may be stored in the vehicle component database 116. Additionally or alternatively, a position of the chassis 12 (FIG. 1) relative to the field 20 may be stored in the vehicle component database 116.

Additionally, in several embodiments, the memory 106 may include a location database 118 storing location data of the work vehicle 10 and/or the boom assembly 38. For example, in some embodiments, a positioning system 122 may be configured to determine the location of the work vehicle 10 and/or the boom assembly 38 by using a satellite navigation positioning system (e.g. a GPS system, a Galileo positioning system, the Global Navigation satellite system (GLONASS), the BeiDou Satellite Navigation and Positioning system, a dead reckoning device, and/or the like). In such embodiments, the location determined by the positioning system 122 may be transmitted to the computing system 102 (e.g., in the form location coordinates) and subsequently stored within the location database 116 for subsequent processing and/or analysis.

In several embodiments, the location data stored within the location database 118 may also be correlated to the application variable data stored within the application variable database 112. For instance, in some embodiments, the location coordinates derived from the positioning system 122 and the application variable data captured by the sensing system 64 may both be time-stamped. In such embodiments, the time-stamped data may allow each individual set of data captured by the sensing system 64 to be matched or correlated to a corresponding set of location coordinates received from the positioning system 122, thereby allowing the data to be associated with a location of the field 20.

Additionally, in some embodiments, such as the one shown in FIG. 4, the memory 106 may include a field database 120 for storing information related to the field 20, such as application map data. In such embodiments, by matching each set of application variable data captured by the sensing system 64 to a corresponding set of location coordinates, the computing system 102 may be configured to generate or update a corresponding application map associated with the field 20, which may then be stored within the field database 120 for subsequent processing and/or analysis. For example, the application variable data captured by the sensing system 64 and/or the positioning system 122 may be mapped or otherwise correlated to the corresponding locations within the application map. Alternatively, based on the location data and the associated sensing system data, the computing system 102 may be configured to generate an application map that includes the geo-located application variable associated therewith.

With further reference to FIG. 4, in several examples, the instructions 110 stored within the memory 106 of the computing system 102 may be executed by the processor 104 to implement one or more modules, such as a control module 124. For example, the control module 124 may be executed or implemented by processor 104 to analyze the data 108. The control module 124 may be executed or implemented by the processor 104 to alter or adjust the operation of one or more components, features, systems, and/or sub-systems of the vehicle 10. For instance, in some examples, the computing system 102 may utilize the control module 124 to adjust or control the operation of one or more components of an agricultural product application system 40, such as by controlling the operation of the nozzle assemblies 46 (e.g., by controlling the nozzle valves 60 using a pulse width modulation (PWM) technique) and/or by controlling any other suitable component of the agricultural product application system 40.

Additionally or alternatively, the computing system 102 may be configured to adjust or control the operation of one or more components, sub-systems, or systems of the boom assembly 38, such as the boom suspension 56 and/or the boom actuators 62. as provided herein, the boom suspension 56 may alter the position of the frame 48 (FIG. 1) of the boom assembly 38 relative to the field 20 and or the chassis 12 (FIG. 1).

Additionally or alternatively, the computing system 102 may be configured to adjust or control the operation of one or more components, sub-systems, or systems of the powertrain control system 22, a steering system 126, a vehicle suspension system 72, and/or any other component. The power plant 24 is configured to vary the output of the engine to control the speed of the vehicle 10. For example, the power plant 24 may vary a throttle setting of the engine, a fuel/air mixture of the engine, a timing of the engine, and/or other suitable engine parameters to control engine output. In addition, the transmission system 26 may adjust a gear selection within a transmission system 26 to control the speed of the vehicle 10. Furthermore, the brake system 28 may adjust braking force, thereby controlling the speed of the vehicle 10. While the illustrated powertrain control system 22 includes the power plant 24, the transmission system 26, and the brake system 28, it will be appreciated that alternative examples may include one or two of these systems, in any suitable combination. Further examples may include a powertrain control system 22 having other and/or additional systems to facilitate adjusting the speed of the vehicle 10.

In various examples, the vehicle suspension system 72 may alter the position of the chassis 12 (FIG. 1) relative to a rolling axis of a corresponding wheel (or any other component) based on an orientation of the vehicle 10 and/or a height of the vehicle 10 (or the boom assembly 38) relative to the field 20.

The control module 124 may also be capable of providing notifications and/or instructions 110 to the user interface 32, a related vehicle notification system 128 (e.g., including components configured to provide visual, auditory, or haptic feedback, such as lights, speakers vibratory components, and/or the like), and/or a remote electronic device 130. In some instances, the control module 124 may generate a notification for the notification system 128 when a reactive change is made to one or more components based on a user-inputted change. For example, in some examples, the user interface 32 may include a display 34 having a touchscreen mounted within the cab 30. The display 34 may be capable of displaying information related to the operation of the vehicle 10 and/or systems or components operably coupled with the vehicle 10. In some examples, the display 34 may include an input device 36 in the form of circuitry within the touchscreen to receive an input corresponding with a location over the display 34. Additionally, the user interface 32 may also include various other types or forms of input devices 36, such as one or more joysticks, buttons, knobs, levers, input pads, and/or any other practicable device.

In several examples, the computing system 102 may be configured to communicate via wired and/or wireless communication with one or more remote electronic devices 130 through a communications device 132 (e.g., a transceiver). The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services. The electronic device 130 may include a display for displaying information to a user. For instance, the electronic device 130 may display one or more user interfaces 32 and may be capable of receiving remote user inputs associated with adjusting operating variables or thresholds associated with the vehicle 10. In addition, the electronic device 130 may provide feedback information, such as visual, audible, and tactile alerts, and/or allow the operator to alter or adjust one or more components, features, systems, and/or sub-systems of the vehicle 10 through the usage of the remote electronic device 130. It will be appreciated that the electronic device 130 may be any one of a variety of computing devices and may include a processor and memory. For example, the electronic device 130 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

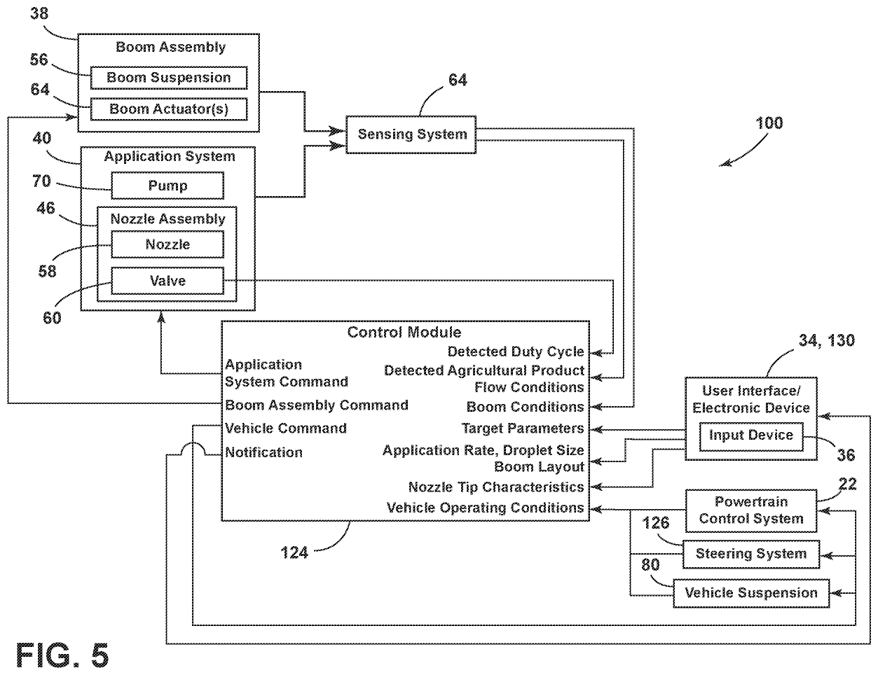

Referring now to FIG. 5, various components of the system 100 are illustrated in accordance with various aspects of the present disclosure. As shown, the control module 124 may receive data 108 from various components of the system 100 and an inputted first command. In turn, the system 100 may determine reactive second commands based on the data 108 and the first command. It will be appreciated if additional data 108 may be provided from the illustrated components and/or other components of the system 100 that are utilized for determining the condition of one or more components of the vehicle 10. As such, the inputs for the control module 124 and/or the outputs for the control module 124 may be varied from the example illustrated in FIG. 5.

As illustrated in FIG. 5, the system 100 provided herein may provide closed-loop control for monitoring and/or generating one or more commands to alter one or more components of the vehicle 10 based on the received commands and/or received data. During the operation of the vehicle 10, an operator may provide a first command to alter one or more components of the vehicle 10. For instance, the inputted first command may be provided from a user interface 34 and/or an electronic device 130. In turn, the agricultural system 100 may generate a reactive second command, possibly with closed-loop control, to update one or more parameters of the sprayer based on the status of various features after the first command, which may be based at least partially on data provided by the sensing system 64. For example, the system 100 may monitor the speed of the vehicle 10 based on one or more first commands during a defined time and, in response, generate a second command for one or more nozzle assemblies 46 to operate within a defined duty cycle range based on the detected speed. Additionally or alternatively, if the boom height is positioned above a defined distance relative to the field 20 and/or above a defined angle relative to the field 20 based on one or more first commands, the system 100 may generate one or more second commands to adjust a pressure of an agricultural product within the application system 40 and/or the weight of the droplets of agricultural product exhausted from the nozzle assemblies 46. Further, if the boom height is below the defined height relative to the ground based on a first command, the system 100 may generate a second command to increase the width of a fan pattern relative to a pattern when the nozzle 58 is at the defined height by changing a fan angle and/or a diameter of a nozzle orifice. Accordingly, the system 100 provided herein may receive a proactive first command (which may be operator inputted and/or automatically generated by the computing system 102), and, in response, the system 100 may generate a reactive second command to alter one or more components of the vehicle 10.

The control module 124 may utilize any data processing techniques or algorithms, such as by applying corrections or adjustments to the data, filtering the data to remove outliers, implementing sub-routines or intermediate calculations, and/or performing any other desired data processing-related techniques or algorithms. In general, the control module 124 may be configured to determine one or more vehicle conditions based on the inputted first command and, in turn, generate a second command, to alter one or more conditions based on the first command. Additionally, or alternatively, in some examples, the control module 124 may alter the operation of the product application system 40 to pause or otherwise change the application of the agricultural product in response to determining that the first command will cause the vehicle 10 to deviate a spray quality index by a defined amount, that one or more vehicle conditions will be adverse to operation and/or the application process, and/or for any other reason. In various examples, the system 100 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system 102 and may be used to generate the second commands. For instance, the control module 124 may receive the first command. In turn, the system 100 may monitor any changes to the actual application condition and/or the spray quality index. Each change may be fed back into the control module 124 for use in the generation of second commands.

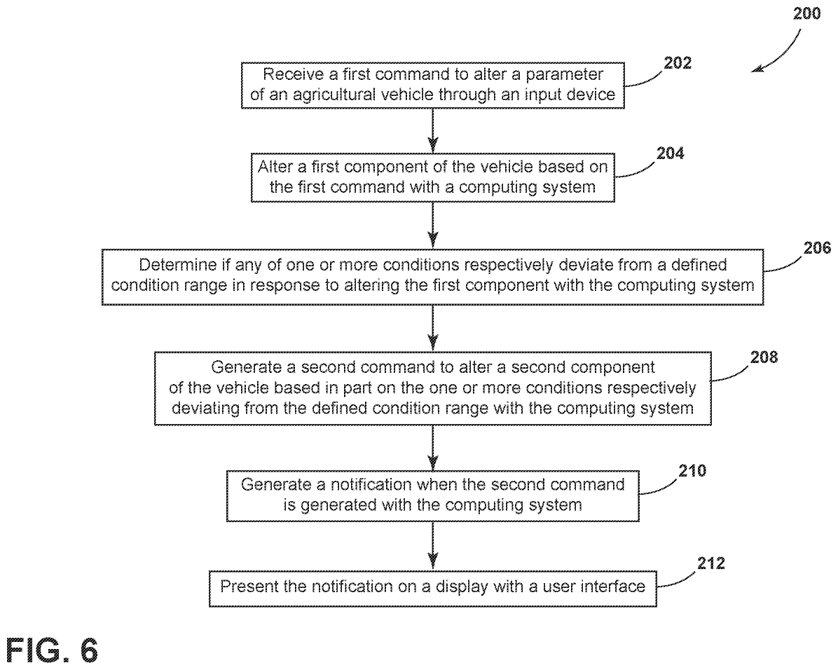

Referring now to FIG. 6, a flow diagram of some embodiments of a method 200 for an agricultural application operation is illustrated in accordance with aspects of the present subject matter. In general, the method 200 will be described herein with reference to one or more nozzle assembly 46 implemented on the work vehicle 10 and the system 100 described above with reference to FIGS. 1-5. However, the disclosed method 200 may generally be utilized with any suitable agricultural work vehicle 10 and/or may be utilized in connection with a system having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202), the method 200 can include receiving a first command to alter a parameter of an agricultural vehicle through an input device. As provided herein the input device can include a user interface, a remote electronic device, and/or any other input device. The parameter may be related to any actuable component of the vehicle, which can affect a spray operation of the vehicle. At (204), the method 200 can include altering a first component of the vehicle based on the first command with a computing system.

At (206), the method 200 can include determining if any of one or more conditions respectively deviate from a defined condition range in response to altering the first component with the computing system. At (208), the method 200 can include generating a second command to alter a second component of the vehicle-based in part on the one or more conditions respectively deviating from the defined condition range with the computing system. In various examples, the second command is generated before the first component being altered from a first condition to a second condition based on the first command. For example, generating the second command to alter a component based in part on the condition of the spray operation deviating from the defined condition range may be at least partially completed prior to the first component being placed in the position dictated by the first command.

In some cases, the first command is a change in a speed of the vehicle during a defined time and the second command alters one or more nozzle assemblies to operate within a defined duty cycle range based at least in part on the first command. Additionally or alternatively, the first command raises a boom to a boom height relative to the field above a defined height and the second command alters a pressure of an agricultural product within the application system. Additionally or alternatively, the first command raises a boom to a boom height relative to the field above a defined height and the second command alters a weight of the droplets of agricultural product exhausted from the nozzle assemblies. Additionally or alternatively, the first command lowers a boom to a boom height relative to the field above a defined height and the second command increases a width of a fan pattern relative to a pattern when the nozzle is at the defined height.

At (210), the method 200 can include generating a notification when the second command is generated with the computing system. At (212), the method 200 can include presenting the notification on a display with a user interface, an electronic device, and/or any other device.

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the boom deflection model. In some instances, the vehicle learning engine may allow for changes to the boom deflection model to be performed without human intervention.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for an agricultural application operation, the method comprising:
receiving, through an input device, a first command to alter a parameter of an agricultural vehicle;
altering, with a computing system, a first component of the vehicle based on the first command;
determining, with the computing system, if any of one or more conditions respectively deviate from a defined condition range in response to altering the first component; and
generating, with the computing system, a second command to alter a second component of the vehicle based in part on the one or more conditions respectively deviating from the defined condition range.

2. The method of claim 1, wherein the first command is a change in a speed of the vehicle during a defined time, and wherein the second command alters one or more nozzle assemblies to operate within a defined duty cycle range based at least in part on the first command.

3. The method of claim 1, wherein the first command raises a boom to a boom height relative to a field above a defined height, and wherein the second command alters a pressure of an agricultural product within the application system.

4. The method of claim 1, wherein the first command raises a boom to a boom height relative to a field above a defined height, and wherein the second command alters a weight of droplets of agricultural product exhausted from one or more nozzle assemblies.

5. The method of claim 1, wherein the first command lowers a boom to a boom height relative to a field above a defined height, and wherein the second command increases a width of a fan pattern relative to a pattern when one or more nozzle assemblies is at the defined height.

6. The method of claim 1, wherein the second command is generated prior to the first component being altered from a first condition to a second condition based on the first command.

7. The method of claim 5, further comprising:
generating, with the computing system, a notification when the second command is generated.

8. The method of claim 7, further comprising:
presenting, with a user interface, the notification on a display.

9. An agricultural system comprising:
a product application system including one or more nozzle assemblies;
a sensing system configured to capture data indicative of a condition of a spray operation;
an input device configured to receive a first command to alter an application parameter for an agricultural product to be exhausted from a nozzle assembly; and
a computing system communicatively coupled to the product application system, the sensing system, and the input device, the computing system being configured to:
receive the first command to alter the parameter;
alter a first component based on the first command;
determine whether the condition of the spray operation deviates from a defined condition range in response to altering the first component; and
generate a second command to alter a second component based on a prediction that the alteration of the first component will cause the condition of the spray operation to deviate from the defined condition range.

10. The system of claim 9, wherein the sensing system comprises:
a flow sensor configured to capture data indicative of a flow condition within the product application system; and
a position sensor operably coupled with a boom assembly operably supporting the one or more nozzle assemblies and configured to capture indicative of a boom position relative to a field.

11. The system of claim 10, wherein the computing system the second command is determined and provided to the second component through closed-loop control.

12. The system of claim 11, wherein the computing system is further configured to:
generate a notification based on the generation of the second command.

13. The system of claim 12, wherein the computing system is further configured to:
present the notification on a display with a user interface.

14. The system of claim 9, wherein the first command is a change in height of a boom relative to a field, and wherein the second command is a change in a weight of an agricultural product.

15. The system of claim 9, wherein the first command is a change in speed of a vehicle operably coupled with the application system, and wherein the second command is an alteration of one or more nozzle assemblies to operate within a defined duty cycle range based at least in part on the first command.

16. A method for an agricultural application operation, the method comprising:
receiving, through an input device, a first command to alter a boom from a first height to a second height relative to a field;
moving, with a suspension system, the boom to the second height;
determining, with a computing system, if a condition of a spray operation deviates from a defined condition range in response to moving the boom to the second height; and
generating, with the computing system, a second command to alter a component based in part on the condition of the spray operation deviating from the defined condition range prior to the boom being placed at the second height.

17. The method of claim 16, wherein the suspension system is a vehicle suspension configured to alter a position of a vehicle chassis relative to the field.

18. The method of claim 16, wherein the suspension system is a boom suspension configured to alter a position of a boom relative to a vehicle chassis.

19. The method of claim 16, further comprising:
generating, with the computing system, a notification when the second command is generated.

20. The method of claim 19, further comprising:
presenting, with a user interface, the notification on a display.
